(19) United States
(12) Patent Application Publication
(10) Pub. No.: US 2025/0385970 A1
(43) Pub. Date: Dec. 18, 2025

(54) SYSTEMS AND METHODS RELATING TO AUTOMATING AFTER-INTERACTION OPERATIONS FOR AGENTS IN A CONTACT CENTER

(71) Applicant: Genesys Cloud Services, Inc., Menlo Park, CA (US)

(72) Inventors: Pavan Buduguppa, Hyderabad (IN); Basil George, Hyderabad (IN); Ramasubramanian Sundaram, Hyderabad (IN); Syed Areeb Ahmad, Hyderabad (IN); Sudhanshu Shekhar, Hyderabad (IN); Allwin Raju, Hyderabad (IN)

(21) Appl. No.: 19/236,222

(22) Filed: Jun. 12, 2025

Related U.S. Application Data
(60) Provisional application No. 63/660,692, filed on Jun. 17, 2024.

(51) Int. Cl. H04M 3/51; G06F 40/166; G06F 40/35; G06F 40/40; G06N 3/045; G06N 3/082; H04M 3/42

(52) U.S. Cl. CPC H04M 3/5175; G06F 40/35; G06F 40/40; G06N 3/045; G06N 3/082; H04M 3/42221; H04M 3/5191; G06F 40/166; H04M 2203/401

(57) ABSTRACT

A method for enabling efficient performance of post interaction operations in a contact center may include obtaining, by a computing system, interaction data indicative of an interaction between a client and an agent of a contact center. The method may further include producing, by the computing system, with an artificial intelligence model trained with low-rank adaptation and as a function of the obtained interaction data, post interaction data to enable the agent to efficiently proceed to a subsequent interaction associated with the contact center. The post interaction data may be indicative of a summarization of the interaction. The method may also include providing, by the computing system, the post interaction data to the agent for confirmation. Further, the method may include storing, by the computing system and in response to receipt of agent feedback, the post interaction data in a data set of the contact center for analytics.

### CROSS-REFERENCE TO RELATED APPLICATIONS

This application claims priority to and the benefit of U.S. Provisional Application No. 63/660,692 titled “SYSTEMS AND METHODS RELATING TO AUTOMATING AFTER-INTERACTION WORK FOR AGENTS IN A CONTACT CENTER,” filed on Jun. 17, 2024, the contents of which are incorporated herein by reference in their entirety.

### BACKGROUND

In a contact center, a set of agents interact with individuals, such as to provide support in relation to products or services. At the conclusion of an interaction, such as a conversation with an end user, the agent prepares a set of post interaction data that summarizes the interaction. Doing so enables future interactions with an individual to be informed by the previous interaction and enables analysis of the performance of the contact center. Typically, to prevent information from being lost or forgotten, the agent is required to prepare the post interaction data before proceeding to interacting with another individual.

### SUMMARY

One embodiment is directed to a unique system, components, and methods for automating after-interaction work for agents in a contact center. Other embodiments are directed to apparatuses, systems, devices, hardware, methods, and combinations thereof automating after-interaction work for agents in a contact center.

According to an embodiment, a method for enabling efficient performance of post interaction operations in a contact center may include obtaining, by a computing system, interaction data indicative of an interaction between a client and an agent of a contact center. The method may further include producing, by the computing system, with an artificial intelligence model trained with low-rank adaptation and as a function of the obtained interaction data, post interaction data to enable the agent to efficiently proceed to a subsequent interaction associated with the contact center. The post interaction data may be indicative of a summarization of the interaction. The method may also include providing, by the computing system, the post interaction data to the agent for confirmation. Further, the method may include storing, by the computing system and in response to receipt of agent feedback, the post interaction data in a data set of the contact center for analytics.

In some embodiments, the method may further include ingesting, by the computing system, historical interaction data indicative of historical interactions between clients and agents associated with the contact center to train the artificial intelligence model to produce the post interaction data. Further, the method may include training the artificial intelligence model with low-rank adaptation for enhanced computational efficiency and storage efficiency, based on the ingested data.

In some embodiments, ingesting historical interaction data comprises redacting one or more predefined types of data from the historical interaction data.

In some embodiments, redacting one or more predefined types of data from the historical interaction data comprises redacting personally identifiable information from the historical interaction data.

In some embodiments, ingesting historical interaction data comprises applying tags to identify distinct fields of post interaction data in the historical interaction data.

In some embodiments, training the artificial intelligence model comprises training a transformer neural network.

In some embodiments, the artificial intelligence model is a pre-trained large language model, and training the artificial intelligence model comprises freezing existing weights on the artificial intelligence model and training one or more adapters that each define a new matrix of weights with lower rank than the existing weights of the artificial intelligence model.

In some embodiments, the artificial intelligence model is a pre-trained large language model, and training the artificial intelligence model comprises indirectly training one or more dense layers of the artificial intelligence model through modification of rank decomposition matrices of the artificial intelligence model.

In some embodiments, obtaining interaction data indicative of an interaction comprises obtaining textual data indicative of a conversation between the client and the agent of the contact center.

In some embodiments, producing the post interaction data comprises producing the post interaction data as a function of an embeddings similarity analysis.

In some embodiments, producing the post interaction data comprises producing the post interaction data as function of a similarity analysis between data indicative of a reason for contact concatenated with resolution description and a set of descriptions associated with wrap up codes that are indicative of corresponding fields of post interaction data.

In some embodiments, producing the post interaction data comprises producing data indicative of one or more key aspects discussed in the interaction, reason data indicative of a reason that the client contacted the contact center, resolution data indicative of a resolution status associated with the interaction, resolution rationale data indicative of an explanation for the resolution status, or follow up action data indicative of one or more actions to be performed after the interaction.

In some embodiments, the method further includes modifying, by the computing system, the post interaction data based on feedback obtained from the agent.

According to another embodiment, a system for enabling efficient performance of post interaction operations in a contact center may include at least one processor and at least one memory comprising a plurality of instructions stored thereon that, in response to execution by the at least one processor, causes the system to obtain interaction data indicative of an interaction between a client and an agent of a contact center. The instructions may also cause the system to produce with an artificial intelligence model trained with low-rank adaptation and as a function of the obtained interaction data, post interaction data to enable the agent to efficiently proceed to a subsequent interaction associated with the contact center. The post interaction data may be indicative of a summarization of the interaction. The instructions may also cause the system to provide the post interaction data to the agent for confirmation and store, in response to receipt of agent feedback, the post interaction data in a data set of the contact center for analytics.

In some embodiments, to the instructions additionally cause the system to ingest historical interaction data indicative of historical interactions between clients and agents associated with the contact center to train the artificial intelligence model to produce the post interaction data. The instructions may further cause the system to train the artificial intelligence model with low-rank adaptation for enhanced computational efficiency and storage efficiency, based on the ingested data.

In some embodiments, to ingest historical interaction data comprises to redact one or more predefined types of data from the historical interaction data.

In some embodiments, to redact one or more predefined types of data from the historical interaction data comprises to redact personally identifiable information from the historical interaction data.

In some embodiments, to ingest historical interaction data comprises to apply tags to identify distinct fields of post interaction data in the historical interaction data.

In some embodiments, to train the artificial intelligence model comprises to train a transformer neural network.

In some embodiments, the artificial intelligence model is a pre-trained large language model, and wherein to train the artificial intelligence model comprises to freeze existing weights on the artificial intelligence model and train one or more adapters that each define a new matrix of weights with lower rank than the existing weights of the artificial intelligence model.

In some embodiments, the artificial intelligence model is a pre-trained large language model, and to train the artificial intelligence model comprises to indirectly train one or more dense layers of the artificial intelligence model through modification of rank decomposition matrices of the artificial intelligence model.

In some embodiments, to obtain interaction data indicative of an interaction comprises to obtain textual data indicative of a conversation between the client and the agent of the contact center.

In some embodiments, to produce the post interaction data comprises to produce the post interaction data as a function of an embeddings similarity analysis.

In some embodiments, to produce the post interaction data comprises to produce the post interaction data as function of a similarity analysis between data indicative of a reason for contact concatenated with resolution description and a set of descriptions associated with wrap up codes that are indicative of corresponding fields of post interaction data.

In some embodiments, to produce the post interaction data comprises to produce data indicative of one or more key aspects discussed in the interaction, reason data indicative of a reason that the client contacted the contact center, resolution data indicative of a resolution status associated with the interaction, resolution rationale data indicative of an explanation for the resolution status, or follow up action data indicative of one or more actions to be performed after the interaction.

In some embodiments, the instructions additionally cause the system to modify the post interaction data based on feedback obtained from the agent.

This summary is not intended to identify key or essential features of the claimed subject matter, nor is it intended to be used as an aid in limiting the scope of the claimed subject matter. Further embodiments, forms, features, and aspects of the present application shall become apparent from the descriptions and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIGS. 3-4 are a simplified flow diagram of at least one embodiment of a computationally efficient method for training an artificial intelligence model to produce post interaction data;

FIG. 5-6 are a simplified flow diagram of at least one embodiment a method for producing post interaction data with an artificial intelligence model;

FIG. 7 illustrates an architecture of an artificial intelligence model that may be utilized to produce post interaction data; and

FIG. 8 illustrates a similarity analysis based on embeddings that may be utilized to produce post interaction data.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The technologies described herein pertain to contact centers and associated cloud-based systems. More particularly, the technologies described herein enable the training and utilization of an artificial intelligence model that provides significant improvements in computational, memory, and storage efficiency over conventional models and that, through the operation of the efficient artificial intelligence model, produces post interaction data to increase the speed of operations of a contact center. That is, the artificial intelligence model offloads after-interaction work from an agent to produce post interaction data, thereby enabling the agent to expediently proceed with interacting with another client (e.g., a customer, an individual, etc.). Among the technical improvements over conventional artificial intelligence models, the technologies described herein enable reduced artificial intelligence model training cost and time, architecture modularization to enable fine tuning of operations of the artificial intelligence model with respect to each of multiple fields of post interaction data without causing regression or deterioration of operations of the model with respect to other fields the post interaction data, and lower memory, compute, and storage resource utilization to produce inferences.

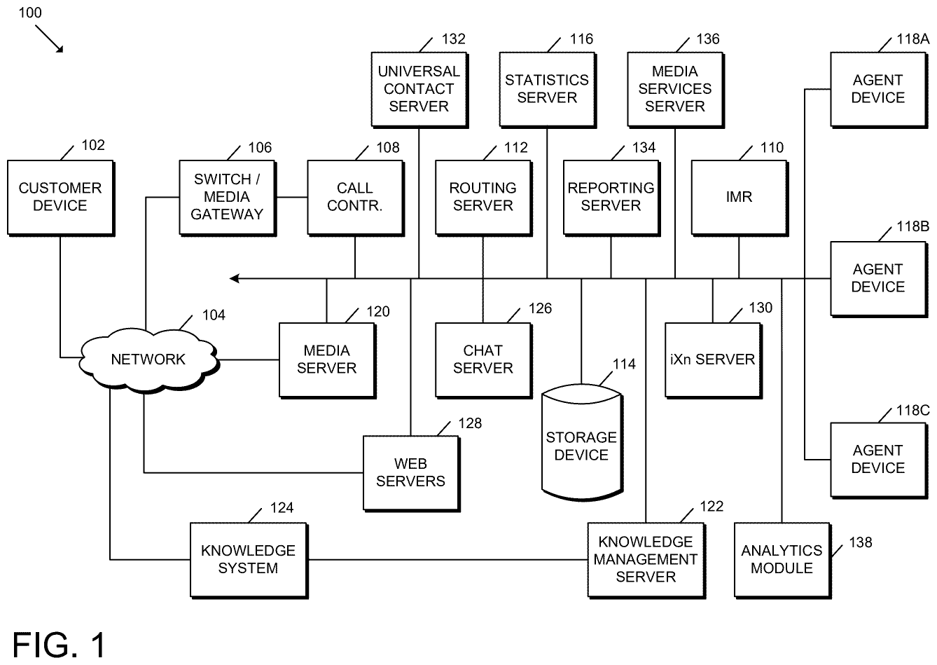

Referring now to FIG. 1, a simplified block diagram of at least one embodiment of a communications infrastructure and/or contact center system, which may be used in conjunction with one or more of the embodiments described herein, is shown. The contact center system 100 may be embodied as any system capable of providing contact center services (e.g., call center services, chat center services, SMS center services, etc.) to a customer and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots,” automated chat modules or “chatbots,” and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

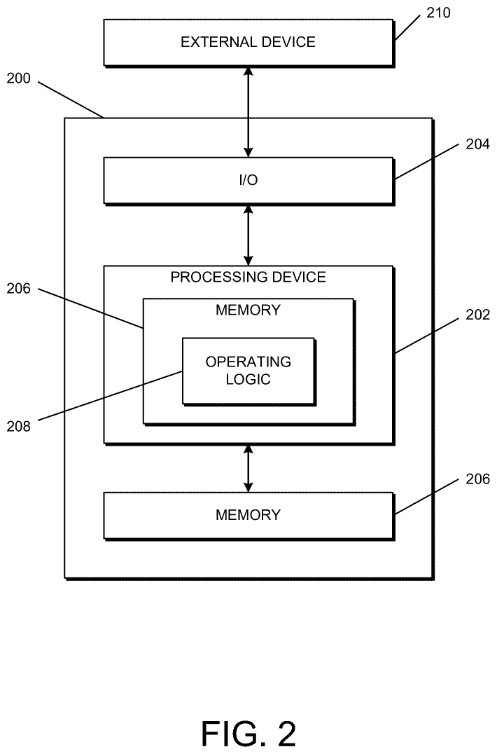

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VOIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VOIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote contact center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, Fire Wire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

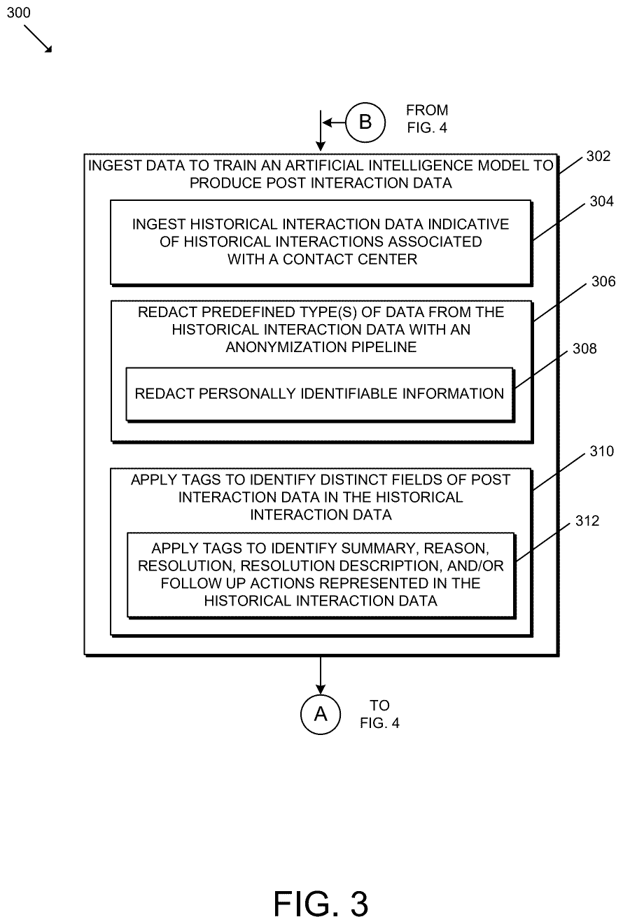

Referring now to FIG. 3, in use, a computing system (e.g., the contact center system 100, one or more computing devices 200, and/or other computing devices described herein) may execute a method 300 for training an artificial intelligence model to produce post interaction data. It should be appreciated that the particular blocks of the method 300 are illustrated by way of example, and such blocks may be combined or divided, added or removed, and/or reordered in whole or in part depending on the particular embodiment, unless stated to the contrary.

The illustrative method 300 begins with block 302 in which the computing system ingests (e.g., obtains) data usable to train an artificial intelligence model to produce post interaction data. As described herein, post interaction data may be embodied as data that summarizes an interaction, and may include an identification, such as a description, of one or more key aspects (e.g., topics, concerns, etc.) discussed in the interaction. The post interaction data may also include reason data, which may be embodied as data indicative of a reason that the client contacted the contact center. The post interaction data may include resolution data which may be embodied as data indicative of a resolution status associated with the interaction. For example, in at least some embodiments, the resolution status may be that the interaction is resolved, that the interaction is partially resolved, or that the interaction is not resolved. The post interaction data may include resolution rationale data indicative of an explanation or description for the resolution status. That is, the resolution rationale data includes one or more statements that explain an underlying reason for the resolution status. For example, for a resolution status indicating partial resolution, the resolution rationale data may indicate that while one concern was resolved, a second concern expressed by the client was not completely resolved during the interaction. The post interaction data may also include follow up action data which may be embodied as data that is indicative of one or more actions to be performed after the interaction, such as to facilitate resolution of any remaining concerns expressed by the client. In some embodiments, a summary of an interaction may include the reason for contact, a resolution value (e.g., resolved, partially resolved, or unresolved), a resolution description indicative of a reasoning behind the resolution value, a follow up value indicative of whether a follow up is needed or not, and a follow up description, indicative of a reasoning behind the follow up value.

In the illustrative embodiment, the computing system ingests historical interaction data indicative of historical (e.g., prior) interactions between clients and agents associated with a contact center, in block 304. As described elsewhere herein, an interaction may be embodied as a communication that takes place between a contact center agent and an outside entity such as a client over any one or more of variety of communication channels, such as, for example, via voice (e.g., telephone calls or voice over IP or VoIP calls), video (e.g., video conferencing), text (e.g., emails and text chat), screen sharing, co-browsing, and/or other communication channels. The historical interaction data, in the illustrative embodiment, is formatted at least primarily as textual data, such as transcripts of interactions, with accompanying data that identifies the context of the interaction, such as the time and date of the interaction, the agent, the client, and summarization information, including, in at least some embodiments, post interaction data generated by the corresponding agent in connection with each interaction.

Further, in the illustrative embodiment, the computing system redacts one or more predefined types of data from the historical interaction data with an anonymization pipeline, in block 306. The anonymization pipeline may be embodied as a set of filters or other operations, each of which is configured to identify a different type of data within the historical interaction data to be delete or modified. For example, the anonymization pipeline may include one or more pattern matching operations, such as pattern matching operations based on regular expression, to identify corresponding data to be deleted or modified. As indicated in block 308, the computing system, in the illustrative embodiment, redacts personally identifiable information from the historical interaction data. For example, the computing system may identify an email address and replace the email address with a stand-in email address or delete the email address. Similarly, the computing system may replace or remove an individual's name, account number, residence address, phone number, or other data that may identify an individual within the historical interaction data. Further, the computing system may perform similar operations to remove any identification of other individuals, other than a customer or client, who may be represented in the historical interaction data.

In block 310, the computing system applies tags to identify distinct fields of post interaction data in the historical interaction data. That is, the post interaction data may not initially demarcate separate fields of post interaction data. Accordingly, the computing system may identify and store data that indicates the presence, position, and type of each field of post interaction data present in the historical interaction data. In some embodiments, the computing system may do so using pattern matching operations, similar to those described above with reference to the anonymization pipeline. Additionally or alternatively, the computing system may utilize an artificial intelligence model, such as a large language model, to identify and tag each field of post interaction data in the historical interaction data based on a determination of similarity to reference examples of each field of post interaction data. In other embodiments, one or more of the fields may be manually tagged by one or more human reviewers of the historical interaction data. In the illustrative embodiment, as indicated in block 312, the computing system applies tags to identify one or more of a summary of each interaction, a reason that the client contacted the contact center, a resolution status for the interaction, a resolution description (e.g., rationale) indicative of the underlying reason(s) for the resolution status, or one or more follow up actions to be performed after the interaction, in the historical interaction data.

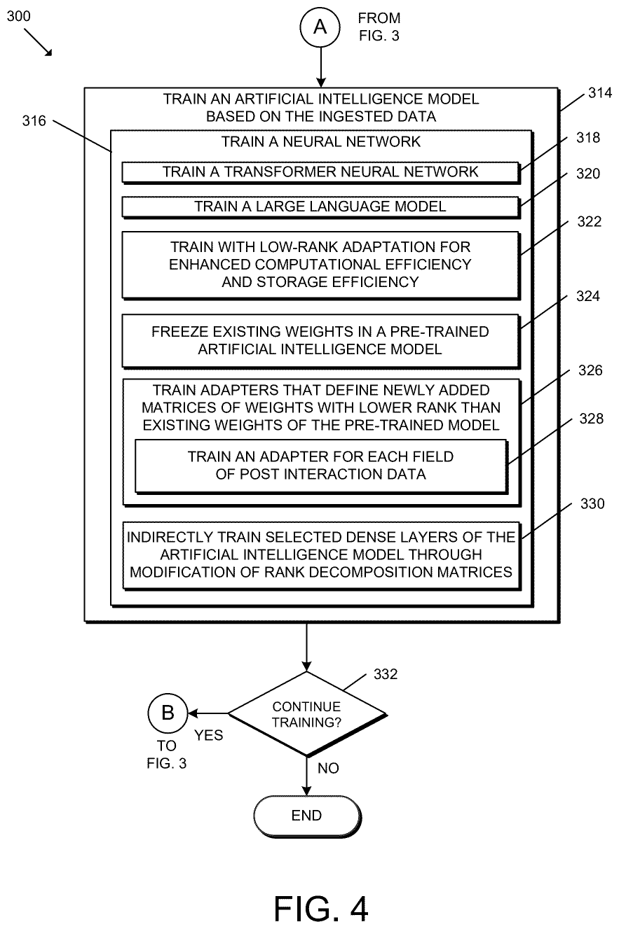

Continuing the method 300 in FIG. 4, the computing system trains the artificial intelligence model based on the ingested data in block 314. In the illustrative embodiment, the ingested data is the historical interaction data, after being anonymized and tagged with indications of fields of post interaction data. In training an artificial intelligence model, the computing system, in the illustrative embodiment, trains a neural network, as indicated in block 316. A neural network, also referred to herein as an artificial neural network, is a set of connected units or nodes that model the neurons in a brain and that are connected via edges, which model synapses in the brain. The nodes are arranged in layers (matrices), including an input layer, one or more hidden layers, and an output layer. Each neuron is configured to receive corresponding signals from connected neurons, then process those signals and produce a resulting signal to other connected neurons. The resulting signal is produced based on an activation function, which is a function that determines an output of a node based on the individual inputs and weights associated with those inputs. The activation function may be, for example, a rectified linear unit activation function, a gaussian error linear unit activation function, or a logistic sigmoid function. In some embodiments, the computing system trains a transformer neural network as indicated in block 318.

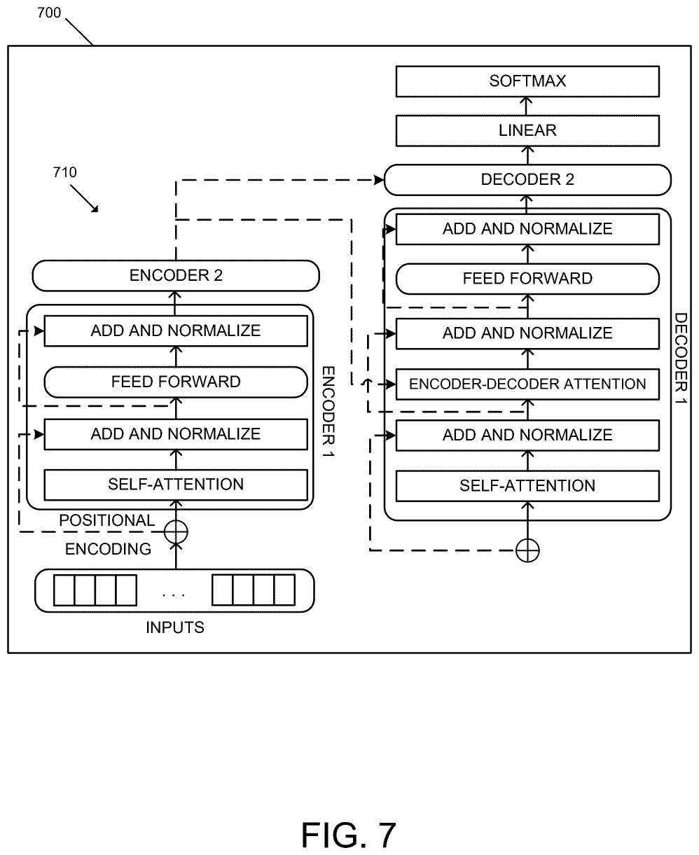

As indicated in block 320, the computing system may train a large language model (LLM). The large language model may be embodied as a machine learning model designed for natural language processing operations, including performing operations based on text-based prompts, and may be trained using supervised and unsupervised learning on a relatively large amount of text. The LLM may, in some embodiments, have a transformer architecture that includes an encoder and a decoder. In a transformer architecture, text is converted into a vector structure through a word embedding table, and in each of multiple layers of the architecture, the transformer contextualizes the token within the scope of a context window with other tokens through a parallel multi-head attention mechanism. Through the architecture, a signal for a key (e.g., significant) token may be amplified and the signal for a less significant token may be de-emphasized. In at least some embodiments, the computing system may train an artificial intelligence model having a base architecture 700 represented in FIG. 7. As described herein, however, the computing system may supplement the base architecture 700 through training of adapters, as described in more detail herein.

In block 322, the computing system may train a neural network (e.g., a large language model) with low-rank adaptation. By training the neural network with low-rank adaption, the computing system enables enhanced computation efficiency and storage efficiency over other training approaches. In performing low-rank adaptation, the computing system, in the illustrative embodiment, freezes (e.g., leaves unmodified) existing weights in the pre-trained artificial intelligence model (e.g., the pre-trained large language model), in block 324. Further, the computing system trains one or more adapters, as indicated in block 326. Each adapter defines or forms a matrix embodied as a layer 710, similar to the layers 710 (e.g., self-attention layer, add and normalize layer, feed forward layer, etc.) of the base model architecture 700. Further, each adapter includes a set of weights having lower rank, such as a lower influence or priority on a resulting output of the model, than existing weights of the pre-trained model (e.g., weight of the existing layers 710 of the architecture 700). In the illustrative embodiment, in block 328, the computing system trains a separate adapter for each field of post interaction data to be operated on by the artificial intelligence model. As such, in the illustrative embodiment, the computing system trains five adapters. Through the above training operations, the computing system, in effect, indirectly trains selected dense layers of the artificial intelligence model through modification of rank decomposition matrices (e.g., the adapters, which have lower-ranked weights than the existing weights in the pre-trained artificial intelligence model), as indicated in block 330.

In block 332, the computing system determines whether to continue training the artificial intelligence model. That is, the computing system may determine whether an accuracy of determinations (e.g., inferences) from the artificial intelligence model satisfies a defined threshold of accuracy, such as by splitting the ingested data into a training set and a verification set and determining whether the artificial intelligence model, when provided with a set of input data associated from the verification set, produces post interaction data that matches the corresponding post interaction data in the verification set with a target level of accuracy. If not, the computing system may loop back to block 302 to potentially ingest further data and perform additional training operations to improve the accuracy of the artificial intelligence model. In other embodiments, the computing system may determine to repeat the training operations on a continual basis, to adjust the artificial intelligence model to changing dynamics associated with the contact center, such as additional or different reasons for contacting the contact center, different resolution statuses or rationales supporting those statuses, different types of follow up actions, or the like.

Although the blocks 302-332 are described in a relatively serial manner, it should be appreciated that various blocks of the method 300 may be performed in parallel in some embodiments.

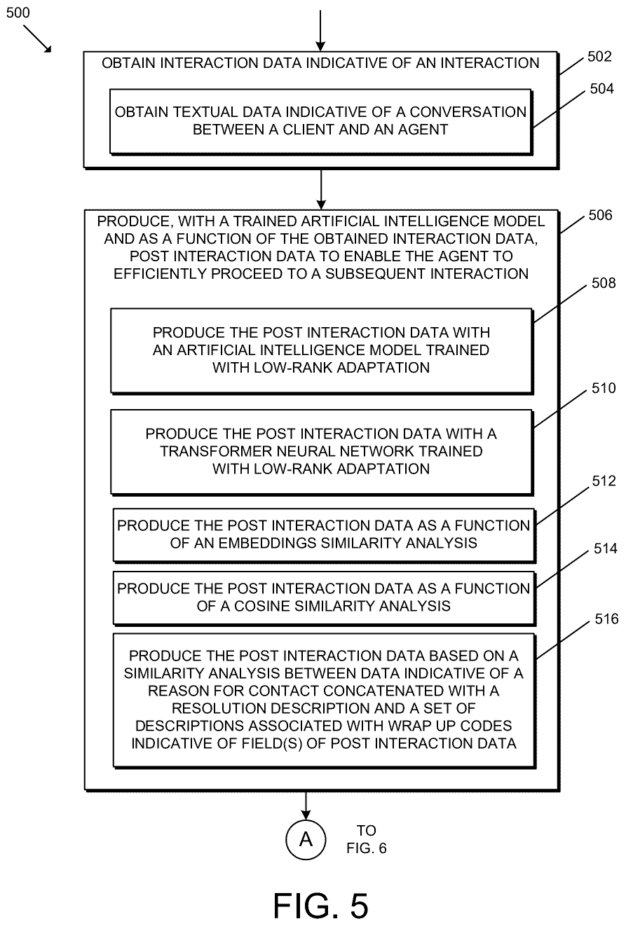

Referring now to FIG. 5, in operation, a computing system (e.g., the contact center system 100, one or more computing devices 200, and/or other computing devices described herein) may execute a method 500 for producing post interaction data with an artificial intelligence model. It should be appreciated that the particular blocks of the method 500 are illustrated by way of example, and such blocks may be combined or divided, added or removed, and/or reordered in whole or in part depending on the particular embodiment, unless stated to the contrary.

The illustrative method 500 begins with block 502 in which the computing system obtains interaction data indicative of an interaction between a client and an agent of a contact center. In doing so, in the illustrative embodiment, the computing system obtains textual data, such as a transcript, of a conversation between the client and the agent, as indicated in block 504. Further, in the illustrative embodiment, the computing system obtains the interaction data at the conclusion of the interaction and prior to the agent beginning an interaction with another client. Continuing the method 500, in block 506, the computing system produces, with a trained artificial intelligence model and as a function of the obtained interaction data (e.g., based on a transcript of a conversation between an agent and a client), post interaction data to enable the agent to efficiently proceed to a subsequent client interaction, such as with another client who has contacted the contact center. That is, the computing system produces the post interaction data for the agent, thereby offloading or significantly reducing an amount of after-interaction work that the agent may otherwise be required to perform.

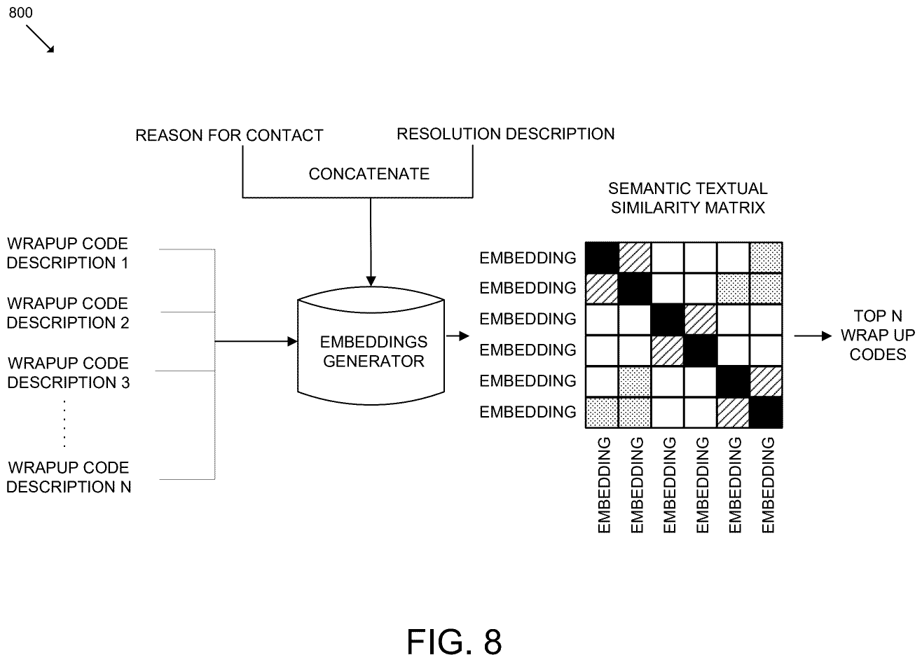

In producing the post interaction data, the computing system may produce the post interaction data with an artificial intelligence model that is trained with low-rank adaptation, as indicated in block 508. In the illustrative embodiment, the computing system produces the post interaction data with a transformer neural network that is trained with low-rank adaptation, in block 510. The computing system may produce the post interaction data at least in part as a function of (e.g., based on) an embedding similarity analysis, in block 512. That is, the computing system may encode numerical representations (embeddings) of real-world objects or concepts represented in textual data, such as the interaction data resulting from the interaction between the agent and the client in block 502, and reference post interaction data, such as from the ingested data from the method 300. The numerical representation may be arranged in a vector, thereby providing the information in a format that is efficiently operated on by an artificial intelligence model. In some embodiments, the computing system may utilize one or more models (e.g., algorithms) to produce the embeddings, such as principal component analysis, singular value decomposition, neural network(s) or other machine learning models, such as Word2Vec and/or BERT. A diagram of similarity analysis operations 800 that may be performed by the computing system using embeddings is represented in FIG. 8. The computing system may perform the post interaction data as a function of a cosine similarity analysis, in block 514. In a cosine similarity analysis, the computing system may determine the cosine of an angle between two vectors (e.g., embeddings). Under such a measure, a greater value for the cosine of the angle between the vectors represents greater similarity while a smaller value for the cosine of the angle represents less similarity. In the illustrative embodiment, in block 516, the computing system may produce the post interaction data based on a similarity analysis between data that is indicative of a reason for contact (e.g., the reason the client contacted the contact center) concatenated with a resolution description (e.g., rationale) indicative of the reason why a particular resolution status is assigned and a set of descriptions associated with wrap up codes. Each wrap up code may be embodied as data indicative of one or more fields of post interaction data. The operations 800 of FIG. 8 represents such a similarity analysis and identification of a resulting set of wrap up codes.

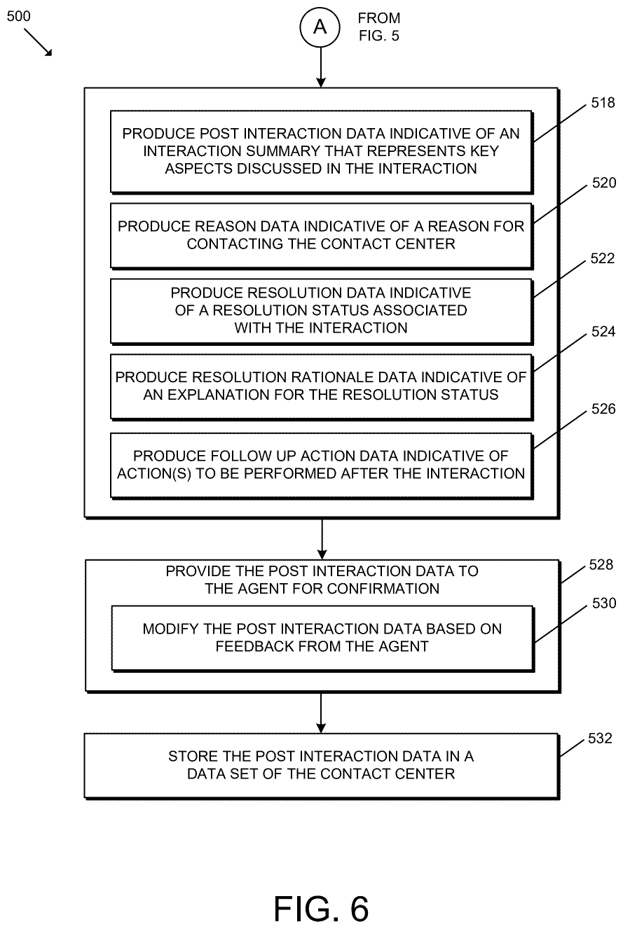

Referring now to FIG. 6, the computing system may provide post interaction data indicative of an interaction summary that represents key (e.g., salient, important, etc.) aspects discussed in the interaction between the agent and the client, in block 518. Further, the computing system may produce reason data indicative of a reason that the client contacted the contact center, in block 520. The computing system may also produce resolution data indicative of a resolution status associated with the interaction, in block 522. In addition, the computing system may produce resolution rationale data indicative of an explanation for the resolution status, in block 524. Further the computing system may produce follow up action data indicative of one or more actions to be performed after the interaction, in block 526. In some embodiments, one or more of the above fields and/or a follow up description indicative of reasoning behind the follow up action data may be incorporated into the interaction summary. The computing system may produce each field of post interaction data based on the operations of a corresponding adapter of the artificial intelligence model trained using low-rank adaptation.

Continuing the method 500, in block 528, the computing system may provide the post interaction data to the agent for confirmation. For example, the computing system may transmit the post interaction data to an agent device 118A, 118B, 118C utilized by the agent, for display thereon. The computing system, in block 530, may modify the post interaction data based on feedback from the agent (e.g., transmitted from the corresponding agent device 118A, 118B, 118C), as indicated in block 526. For example, in at least some embodiments, the computing system may provide multiple sets of potential post interaction data for consideration by the agent, and the agent may select one set as a final set of post interaction data to be associated with the interaction. Additionally or alternatively, the agent may edit the content of one or more fields of the post interaction data produced by the computing system. In block 532, the computing system stores the post interaction data in a data set (e.g., in the storage device 114) of the contact center. The computing system may perform analytics on the post interaction data, such as through the operations of the analytics module 138, described above in connection with FIG. 1.

Although the blocks 502-532 are described in a relatively serial manner, it should be appreciated that various blocks of the method 300 may be performed in parallel in some embodiments.

Further to the above methods 300, 500, as described above, in the illustrative embodiment, the computing system, in the illustrative embodiment, utilizes a large language model based on a transformer architecture. The LLM, in the illustrative embodiment, is initiated with a random set of weights and is pre-trained on a large set of open source data, such as wiki articles or text data scraped from the open internet. The computing system may then fine tune the pre-trained model for specific tasks. In the illustrative embodiment, the artificial intelligence model is of Flan T5 family. An embodiment of an architecture 700 of the model (the base model) is represented in FIG. 7.

In training the artificial intelligence model, in the illustrative embodiment, the computing system does not train all of the layers, weights, or parameters of the base model. Rather, the computing system keeps all of the weights frozen (e.g., unchanged) except for newly added weight matrices that have significantly lower rank or impact on the output of the model compared to the existing weights. That is, the computing system, in the illustrative embodiment, trains the artificial intelligence model through low-rank adaptation (LoRA) of a large language model. An important paradigm of natural language processing is large-scale pretraining on general domain data and adaptation to particular tasks or domains. As larger models are pre-trained, full fine-tuning, which retrains all model parameters, becomes less feasible. Using GPT-3 175B as an example, deploying independent instances of fine-tuned models, each with 175 billion parameters, is prohibitively expensive in terms of compute resources, time, and energy. By contrast, training the model with low-rank adaptation as described herein, which freezes the pretrained model weights and injects trainable rank decomposition matrices into each layer of the transformer architecture, greatly reduces the number of trainable parameters for downstream tasks. Compared to GPT-3 175B fine-tuned with Adam, training the artificial intelligence model with low-rank adaptation can reduce the number of trainable parameters by 10,000 times and the graphics processing unit memory requirement by three times. LoRA performs on-par or better than finetuning in model quality on ROBERTa, DeBERTa, GPT-2, and GPT-3, despite having fewer trainable parameters, a higher training throughput, and, unlike adapters, no additional inference latency. Learned over-parametrized models reside on a low intrinsic dimension. The change in weights during model adaptation has a low intrinsic rank. As such, by utilizing low-rank adaptation, the computing system obtains a significant technical advantage over conventional artificial intelligence models as the training approach enables training a subset of dense layers in a neural network indirectly. More specifically, the computing system optimizes rank decomposition matrices during adaptation, while keeping the pre-trained weights frozen. Using GPT-3 175B as an example, a relatively low rank (e.g., one or two) suffices even when the full rank is as high as 12,288. As such, the computing system utilizes a training approach that is both storage and compute efficient.

In the illustrative embodiment, the lower ranked matrices (adapters) are kept separate for each field of the post interaction data. By separating the adapters, the computing system obtains lower training cost and time. Further, the fields of the post interaction data are kept disjointed from each other. Accordingly, if a need arises to fine tune a field further, the fine tuning does not affect or cause a regression or deterioration in the accuracy of operations associated with other fields of the post interaction data. Further, the approach utilized by the computing system enables a lower inference memory footprint, as there is only one base model that the adapters are based on. Accordingly, instead of loading five separate fine tuned base models, the computing system may load one based model and five relatively small adapters. The adapter-based approach may be utilized not only for the fields of the post interaction data, but also for supporting other natural languages other than English. For example the computing system may support the Spanish language with the post interaction fields with five additional adapters.

Wrap up codes, also referred to as disposition codes, are used in contact centers to categorize the outcome of interactions between agents and clients. The wrap up codes are typically selected by agents after an interaction (e.g., call, chat, or other form of interaction). The wrap up codes assist in summarizing the reason for the contact and the resolution status. Wrap up codes are useful for tracking, reporting, and analyzing interactions to improve service quality and efficiency.

Selecting a wrap up code produces a cognitive load on a contact center agent. The computing system, in the illustrative embodiment, identifies a set of wrap up codes relevant to a conversation through the operations represented in FIG. 8. In doing so, the computing system may identify a set of top relevant wrap up codes based on reason and resolution description fields, which act as a proxy for information in the conversation (the interaction) between the agent and the client. The computing system provides the concatenated fields and wrap up code descriptions are provided to an embeddings generator that generates corresponding embeddings, A and B. Further, in the illustrative embodiment, the computing system determines the similarity between the embeddings using Equation 1, shown below.

$$cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} . \qquad ( Equation 1 )$$

Based on the determined similarity, the computing system may select a set of wrap up codes having the N greatest similarity scores (e.g., cosine similarity from Equation 1 above) for presentation to the agent, in which N is a positive, non-zero integer.

What is claimed is:

1. A method for enabling efficient performance of post interaction operations in a contact center, the method comprising:
obtaining, by a computing system, interaction data indicative of an interaction between a client and an agent of a contact center;
producing, by the computing system, with an artificial intelligence model trained with low-rank adaptation and as a function of the obtained interaction data, post interaction data to enable the agent to efficiently proceed to a subsequent interaction associated with the contact center, wherein the post interaction data is indicative of a summarization of the interaction;
providing, by the computing system, the post interaction data to the agent for confirmation; and
storing, by the computing system and in response to receipt of agent feedback, the post interaction data in a data set of the contact center for analytics.

2. The method of claim 1, further comprising:
ingesting, by the computing system, historical interaction data indicative of historical interactions between clients and agents associated with the contact center to train the artificial intelligence model to produce the post interaction data; and
training the artificial intelligence model with low-rank adaptation for enhanced computational efficiency and storage efficiency, based on the ingested data.

3. The method of claim 2, wherein ingesting historical interaction data comprises redacting one or more predefined types of data from the historical interaction data.

4. The method of claim 2, wherein ingesting historical interaction data comprises applying tags to identify distinct fields of post interaction data in the historical interaction data.

5. The method of claim 2, wherein training the artificial intelligence model comprises training a transformer neural network.

6. The method of claim 2, wherein the artificial intelligence model is a pre-trained large language model, and training the artificial intelligence model comprises:
freezing existing weights on the artificial intelligence model; and
training one or more adapters that each define a new matrix of weights with lower rank than the existing weights of the artificial intelligence model.

7. The method of claim 2, wherein the artificial intelligence model is a pre-trained large language model, and training the artificial intelligence model comprises indirectly training one or more dense layers of the artificial intelligence model through modification of rank decomposition matrices of the artificial intelligence model.

8. The method of claim 1, wherein obtaining interaction data indicative of an interaction comprises obtaining textual data indicative of a conversation between the client and the agent of the contact center.

9. The method of claim 8, wherein producing the post interaction data comprises producing the post interaction data as a function of an embeddings similarity analysis.

10. The method of claim 8, wherein producing the post interaction data comprises producing the post interaction data as function of a similarity analysis between data indicative of a reason for contact concatenated with resolution description and a set of descriptions associated with wrap up codes that are indicative of corresponding fields of post interaction data.

11. The method of claim 1, wherein producing the post interaction data comprises producing data indicative of one or more key aspects discussed in the interaction, reason data indicative of a reason that the client contacted the contact center, resolution data indicative of a resolution status associated with the interaction, resolution rationale data indicative of an explanation for the resolution status, or follow up action data indicative of one or more actions to be performed after the interaction.

12. The method of claim 1, further comprising modifying, by the computing system, the post interaction data based on feedback obtained from the agent.

13. A system for enabling efficient performance of post interaction operations in a contact center, the system comprising:
at least one processor; and
at least one memory comprising a plurality of instructions stored thereon that, in response to execution by the at least one processor, causes the system to:
obtain interaction data indicative of an interaction between a client and an agent of a contact center;
produce with an artificial intelligence model trained with low-rank adaptation and as a function of the obtained interaction data, post interaction data to enable the agent to efficiently proceed to a subsequent interaction associated with the contact center, wherein the post interaction data is indicative of a summarization of the interaction;
provide the post interaction data to the agent for confirmation; and
store, in response to receipt of agent feedback, the post interaction data in a data set of the contact center for analytics.

14. The system of claim 13, wherein the instructions additionally cause the system to:
ingest historical interaction data indicative of historical interactions between clients and agents associated with the contact center to train the artificial intelligence model to produce the post interaction data; and
train the artificial intelligence model with low-rank adaptation for enhanced computational efficiency and storage efficiency, based on the ingested data.

15. The system of claim 14, wherein to ingest historical interaction data comprises to redact one or more predefined types of data from the historical interaction data.

16. The system of claim 14, wherein to ingest historical interaction data comprises to apply tags to identify distinct fields of post interaction data in the historical interaction data.

17. The system of claim 14, wherein to train the artificial intelligence model comprises to train a transformer neural network.

18. The system of claim 14, wherein the artificial intelligence model is a pre-trained large language model, and wherein to train the artificial intelligence model comprises to:
freeze existing weights on the artificial intelligence model; and
train one or more adapters that each define a new matrix of weights with lower rank than the existing weights of the artificial intelligence model.

19. The system of claim 14, wherein the artificial intelligence model is a pre-trained large language model, and to train the artificial intelligence model comprises to indirectly train one or more dense layers of the artificial intelligence model through modification of rank decomposition matrices of the artificial intelligence model.

20. The system of claim 13, wherein to obtain interaction data indicative of an interaction comprises to obtain textual data indicative of a conversation between the client and the agent of the contact center.
